(19) United States
(12) Patent Application Publication
(10) Pub. No.: US 2024/0013435 A1
(43) Pub. Date: Jan. 11, 2024

(54) CALIBRATION ARRANGEMENT

(71) Applicant: INUITIVE LTD., Ra'anana (IL)

(72) Inventors: Mishel IVGI, Yehud-Monoson (IL); Michael GERMAN, Modiin (IL)

(21) Appl. No.: 17/810,970

(22) Filed: Jul. 6, 2022

(51) Int. Cl. G06T 7/80; H05B 47/155; H05B 47/185

(52) U.S. Cl. CPC G06T 7/80; H05B 47/155; H05B 47/185

(57) ABSTRACT

A calibration arrangement, configured to enable camera calibration, characterized in that it comprises a plurality of lighting zones, each illuminated by respective light sources operative at at least two different wavelengths, wherein the illumination of the plurality of lighting zones ensures that when illuminated, no shadow is casted upon any of the plurality of lighting zones, although at least some of the plurality of lighting zones are positioned orthogonally to each other, wherein currents provided to the plurality of lighting zones are controlled by a respective plurality of zone controllers, and wherein these currents are conveyed to each of the plurality of lighting zones via Ethernet cables.

### TECHNICAL FIELD

The present disclosure generally relates to the field of optics, and more particularly, it relates to the field of lighting.

### BACKGROUND

Camera calibration is the process of estimating intrinsic and/or extrinsic parameters associated with the camera. Intrinsic parameters deal with the camera's internal characteristics, such as, its focal length, skew, distortion, and image center. Extrinsic parameters describe its position and orientation in the world.

Knowing intrinsic parameters is an essential first step for 3D computer vision, as it allows you to estimate the scene's structure in Euclidean space and removes lens distortion, which degrades accuracy.

A typical camera calibration procedure that is used in the art, comprises the following steps:
1. Selecting a pattern (and have it printed (examples of such patterns are demonstrated in FIG. 1);
2. Mounting the printed pattern onto a rigid flat surface;
3. Capturing many images of the target with the camera at different orientations and distances;
4. Selecting from among the captured images those that are in focus; and
5. Applying provided examples to automatically detect calibration target and compute parameters thereof.

However, as may be appreciated, this solution is a cumbersome solution that should be preferably replaced with an easier to use solution. One such a solution relies on using a calibration target such as the one illustrated in FIG. 2. This example 3D calibration target is used for geometric calibration of a plenoptic camera or a stereo camera system. The model parameters are estimated from a set of images in a full bundle adjustment, for which the 3D calibration target shown in FIG. 2 may be used. In a bundle adjustment, all parameters of the camera models, the extrinsic orientations of the single images as well as the 3D coordinates of the calibration markers are estimated. The micro images of the plenoptic camera generally do not cover a complete marker point. Therefore, the marker points cannot be detected reliably in the micro images. Hence, one needs to calculate from each raw image, recorded by the plenoptic camera, the corresponding totally focused image. Afterwards, the marker points are detected in the totally focused image and are projected back to the micro images in the respective raw image.

When carrying out a Camera Calibration in a Lightroom using panel stack, the process is typically split into a few sub-processes: RGB Primaries, Shadow Tint, Camera Profile, and Process.

The RGB Primaries section tweaks the overall color mix in the captured image. However, each camera manufacturer has a different profile calibrated for a specific camera model and these values can differ dramatically between manufacturers. Changing these values differs from changing the values in the HSL panel because they affect the overall definition of red, green, or blue. Changing blues in the HSL panel will target areas of the image that appear blue, whereas changing blues in the Camera Calibration panel will affect all pixels that contain blue in their mix.

The Shadow Tint is a somewhat more straightforward sub-process: in this sub-process the color cast those shadows have, is changed, with green and magenta canceling each other out.

The Camera Profile options match the profiles that are available on the camera being calibrated. When a ‘scene’ or a profile mode is selected on the calibrated camera, it will change the way the image is processed to JPG. This panel gives you the opportunity to apply a profile of your choice in post.

Finally, the Process section will change the entire process engine that Lightroom uses.

The present disclosure aims to provide a solution for the calibration of a camera using a distributed lighting system in which calibration is carried out using a plurality of lighting areas, a solution that will ensure that one configuration will yield the same results in all the test stations without requiring to a carry out calibration process for a new test station.

### SUMMARY OF THE DISCLOSURE

The disclosure may be summarized by referring to the appended claims.

It is an object of the present invention to provide a novel multi-zone lighting arrangement for camera calibration having a uniform lighting.

It is another object of the present disclosure to provide a multi-zone lighting arrangement for camera calibration under different wavelengths.

It is another object of the present invention to provide a multi-zone lighting arrangement having a single power supply for easy installation.

It is another object of the present invention to provide a multi-zone lighting arrangement for camera calibration having a consistent, separate and accurate intensity control for each of the lighting zones.

It is another object of the present invention to provide a multi-zone lighting arrangement that can be operated upon installation, eliminating the need to pre-calibrate that calibration arrangement.

Other objects of the present invention will become apparent from the following description.

According to an embodiment of the disclosure, there is provided a calibration arrangement, configured to enable camera calibration, wherein the calibration arrangement is characterized in that it comprises a plurality of lighting zones, each illuminated by respective light sources operative at at least two different wavelengths, wherein the illumination of the plurality of lighting zones ensures that when illuminated, no shadow is casted upon any of the plurality of lighting zones, although at least some of the plurality of lighting zones are positioned orthogonally to each other, wherein currents provided to the plurality of lighting zones are controlled by a respective plurality of zone controllers, and wherein these currents are conveyed to each of the plurality of lighting zones via Ethernet cables.

According to another embodiment of the present disclosure, each lighting zone comprises illuminators configured to operate at three wavelengths, being visible light, 850 nm and 940 nm. Preferably but not necessarily, the visible light is white light.

In accordance with another embodiment of the present disclosure, the power received at each lighting zone is divided unequally between illuminators, so that all illuminators that are operative at one wavelength will be provided with a power that is different from the power that will be provided to all illuminators that belong another wavelength. For example, at one or more of the lighting zones, the visible light illuminators receive 35% of the power, the 850 nm illuminators receive 45% of the power and the 940 nm illuminators receive any other value between 0% and 100%.

By yet another embodiment, all illuminators associated with each one of the plurality of lighting zones and belong to a certain wavelength, will be serially connected to each other, assuring the same current flows through all the illuminators.

In accordance with still another embodiment of the present disclosure the calibration arrangement is a plug-and-play arrangement adapted to provide the same lighting performance wherever it is installed.

### BRIEF DESCRIPTION OF THE DRAWINGS

For a more complete understanding of the present invention, reference is now made to the following detailed description taken in conjunction with the accompanying drawings wherein:

FIG. 1—illustrates various patterns used in the art to calibrate cameras;

FIG. 2—illustrates a 3D calibration target that is used in the art for geometric calibration;

FIG. 3—demonstrates a schematic diagram of a 3D calibration target for use with the arrangement construed in accordance with an embodiment of the present invention;

FIG. 4—illustrates a strip of LED illuminators configured to be used in a lighting zone of the 3D calibration target of FIG. 3; and

FIG. 5—illustrate a schematic diagram of a calibration arrangement construed in accordance with an embodiment of the present invention.

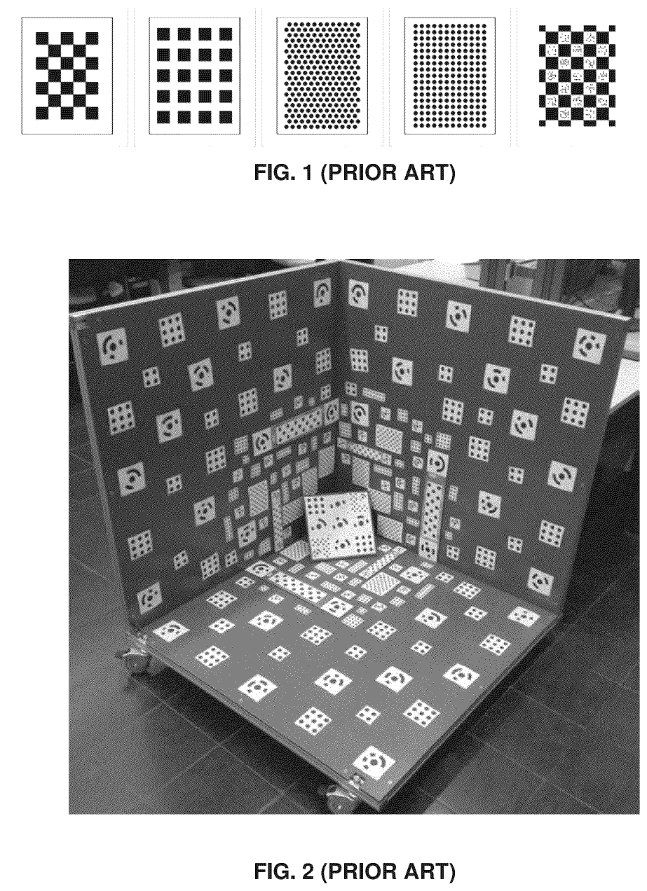

### DETAILED DESCRIPTION

In this disclosure, the term “comprising” is intended to have an open-ended meaning so that when a first element is stated as comprising a second element, the first element may also include one or more other elements that are not necessarily identified or described herein or recited in the claims.

In the following description, for the purposes of explanation, numerous specific details are set forth in order to provide a better understanding of the present invention by way of examples. It should be apparent, however, that the present invention may be practiced without these specific details.

As already explained, there is a need for a camera calibration set up that is configured to provide accurate calibration results on the one hand, and to ensure that the results are reproducible, irrespective of where that setup is installed.

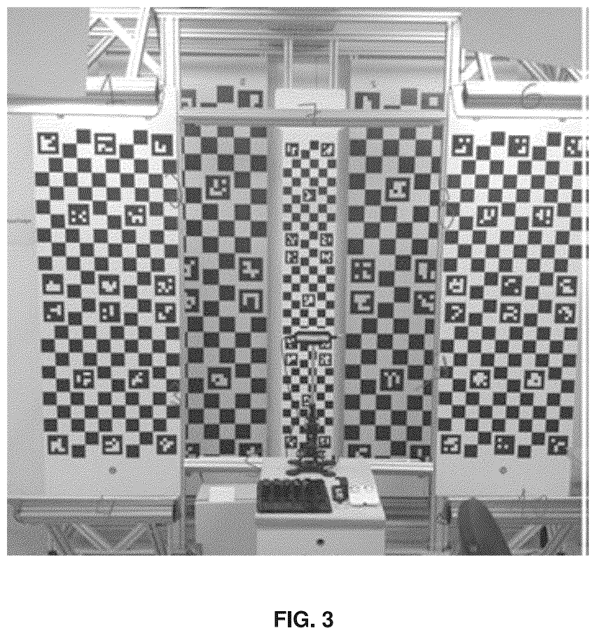

FIG. 3 illustrates such a calibration setup. It comprises 10 zones, each comprised of a plurality of different calibration panels and comprises in this example three light sources, one visible source, and the other two sources at the Near Infrared (NIR) range, one of which is a source at a wavelength of 840 nm and the other at a wavelength of 940 nm. As may be seen in FIG. 3 that at least some of the zones are mounted in a way that they are positioned orthogonally to each other.

Preferably, there is a single point of power input is implemented for easy installation of the calibration setup, where illumination is achieved by utilizing a main controller for the arrangement, configured to distribute power to the various illumination zones, and by applying an efficient power level control per each of the illumination zones for each light source, thus bringing the arrangement of this example to a total of 30 fully controlled lighting zones, where the overall control of the setup aims to provide a uniform lighting. The main power supply provides a 48V power source which allows usage of long and narrow power cables. Preferably, this setup is not sensitive to voltage drops and can sustain a voltage drop of ˜15V without having any effect on the programmed lighting setup. This in turn allows a very easy installation, using off-the-shelf, standard CAT5 Ethernet cables.

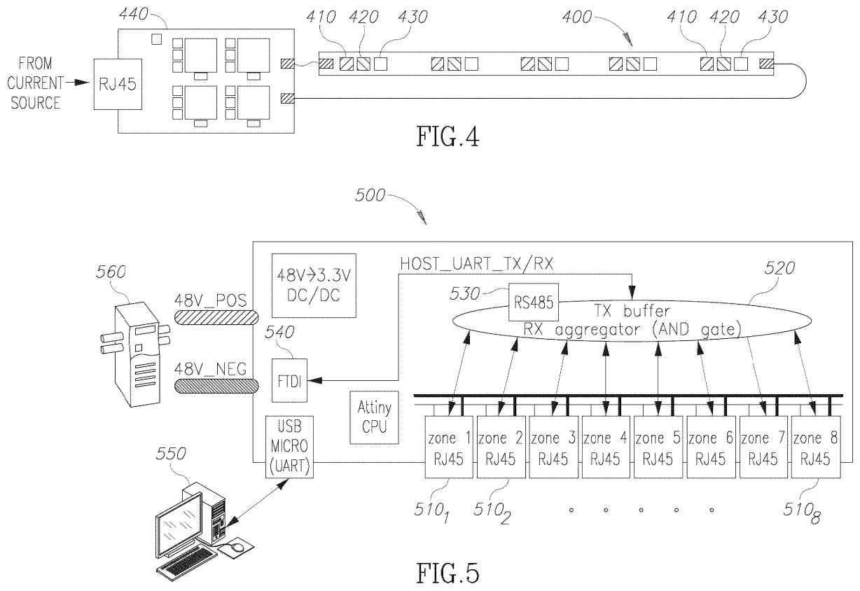

Each of the three light sources described in this example comprises a strip 400 of LED illuminators, as exemplified in FIG. 4, using a current source that is configured to provide a constant current, to the LEDs. The LEDs are serially connected to each other per their operating wavelength. The 940 nm LEDs 410 are serially connected to each other, the 850 nm LEDs 420 are serially connected to each other, and the white light LEDs 430 are serially connected to each other. Each zone controller is a small PCB 440 that is configured to provide power, to enable dimming functionality and to control the current being provided up to say 15 LED groups, where each group contains 3 LED types, one per a wavelength. Voltage drop on the cables is mitigated by using a 48V (or higher, preferably up to 60V) power supply.

The LEDs illuminators are preferably mounted on a LED board, which is a narrow PCB (e.g., a PCB having dimensions of about 300×10 mm) which comprises 15 LED illuminators (5 groups, each comprising 840 nm LED, 940 nm LED and a white light LED), which could be cascaded in series of up to 2 units at 0.5 A or higher, if required.

Finally, according to an embodiment of the present invention, Ethernet cables are used to transfer power to the zone controllers discussed above. One option for such Ethernet cables may be using standard CAT5e Ethernet cables, which, by using a voltage source of 48V, and implementing a current source design, makes it is possible to assure that the design is not sensitive to voltage drops on the Ethernet cables, which in turn ensures that the lighting intensity (level) is not affected by the length of the cables used.

The Ethernet cables which are used each to convey power to the respective LEDs in a lighting zone ends with a connector RJ-45 which is a physical network interface for connecting telecommunications or data equipment. The Ethernet cable is used to transfer power from the main controller as well as a digital communication channel used to set op the required current per zone and per light source.

FIG. 5 illustrates a schematic diagram of a calibration arrangement 500 construed in accordance with an embodiment of the present invention. Arrangement 500 comprises 8 lighting zones 5101 to 510e, which are configured to communicate via their respective RJ-45 connectors with transmitter buffer 520 via an RS-485 device 530, being an industrial standard that defines the electrical interface and physical layer for point-to-point communication of electrical devices. The RS-485 standard allows for long cabling distances in electrically noisy environments and can support a plurality of such electrical devices on the same bus. The RS-485 device 530 is configured to communicate with FTDI USB 540 which is used for communication to and from microcontroller 550, which in turn enables controlling the power received from 48V power supplier 560 that feeds the various lighting zones. Microcontroller 530 helps to direct the communication between the host PC (550) and the zone controllers. The PC host application defines for them the lighting demands which is translated for each LED for its own specific illumination intensity.

The specific operating conditions for each LED in the arrangement are stored as default lighting conditions (including the operating wavelength of the LED, the power to be consumed by that LED, etc.), so that once this arrangement (or another arrangement having the same configuration), is installed at a different location and operated, it can immediately be used as a successful camera calibration station, without have to pre-calibrate the calibration station.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention in any way. The described embodiments comprise different objects, not all of which are required in all embodiments of the invention. Some embodiments of the present invention utilize only some of the objects or possible combinations of the objects. Variations of embodiments of the present invention that are described and embodiments of the present invention comprising different combinations of features noted in the described embodiments will occur to persons of the art. The scope of the invention is limited only by the following claims.

1. A calibration arrangement, configured to enable camera calibration, wherein the calibration arrangement is characterized in that it comprises a plurality of lighting zones, each illuminated by respective light sources operative at at least two different wavelengths, wherein the illumination of the plurality of lighting zones ensures that when illuminated, no shadow is casted upon any of the plurality of lighting zones, although at least some of the plurality of lighting zones are positioned orthogonally to each other, wherein currents provided to the plurality of lighting zones are controlled by a respective plurality of zone controllers, and wherein these currents are conveyed to each of the plurality of lighting zones via Ethernet cables.

2. The calibration arrangement of claim 1, wherein each lighting zone comprises illuminators configured to operate at three wavelengths, being visible light, 850 nm and 940 nm.

3. The calibration arrangement of claim 1, wherein power received at each lighting zone is divided unequally between illuminators, so that all illuminators that are operative at one wavelength will be provided with a power that is different from the power that will be provided to all illuminators that belong another wavelength.

4. The calibration arrangement of claim 1, wherein all illuminators associated with each one of the plurality of lighting zones and that belong to a certain wavelength, will be serially connected to each other, assuring the same current flows through all the illuminators.

5. The calibration arrangement of claim 1, being a plug-and-play arrangement adapted to provide the same lighting performance wherever it is installed.
